(19) United States
(12) Patent Application Publication
(10) Pub. No.: US 2025/0206385 A1
(43) Pub. Date: Jun. 26, 2025

(54) FRONT REGION OF A PASSENGER COMPARTMENT

(71) Applicant: GF Casting Solutions AG, Schaffhausen (CH)

(72) Inventors: Stephan PHILIPP, Gailingen (DE); Marc GUNIA, Schaffhausen (CH); Benedikt STARK, Stühlingen (DE); Steven TSCHEPE, Aach (DE)

(21) Appl. No.: 18/986,967

(22) Filed: Dec. 19, 2024

(30) Foreign Application Priority Data
Dec. 21, 2023 (EP) 23218947.2

(51) Int. Cl. B62D 25/14; B62D 25/04

(52) U.S. Cl. CPC B62D 25/145; B62D 25/04

(57) ABSTRACT

A front region of a passenger compartment of a motor vehicle, including two mutually opposing A-pillars, a bulkhead which delimits in a longitudinal direction of the motor vehicle, and a crossbeam. The crossbeam extends transversely with respect to the longitudinal direction of the motor vehicle from a first A-pillar of the mutually opposing A-pillars to a second A-pillar of the mutually opposing A-pillars. The crossbeam is supported or mounted exclusively on the mutually opposing A-pillars. The crossbeam is in a form of a die-cast component.

### CROSS REFERENCE TO RELATED APPLICATIONS

This application claims benefit to European Patent Application No. EP 23218947.2, filed on Dec. 21, 2023, which is hereby incorporated by reference herein.

### FIELD

The invention relates to a front region of a passenger compartment of a motor vehicle.

### BACKGROUND

In current motor vehicles, in order to secure various cockpit functions, there is generally provided as a supporting component a crossbeam which extends substantially exclusively horizontally from one A-pillar to the opposing A-pillar and which is supported in the centre by means of an additional support on the vehicle base. Other separately configured components which have different functions, such as, for example, a pedal receiving member, a support with respect to the bulkhead or a fastening for an imaging unit of a head-up display, and other components, are secured on the crossbeam. In order to optimize the stability of the crossbeam which extends over the entire motor vehicle width and to which other components are secured, the crossbeam has between the driver and the passenger a tunnel-like brace for additional support, which additionally subdivides the footwell into a driver region and passenger region.

DE 10 2013 212 878 A1 discloses a structural cockpit component which contains a cockpit crossbeam which has a support foot which is supported in a downward direction on the vehicle base. The footwell of the driver and passenger is thereby subdivided into two regions by means of a central console or a central tunnel-like member which surrounds the support foot.

DE 10 2017 004 695 A1 discloses a passenger compartment in which, in addition to a central tunnel-like member, another support of the instrument panel is carried out by means of an additional storage console in the passenger region.

### SUMMARY

In an embodiment, the present disclosure provides a front region of a passenger compartment of a motor vehicle, comprising two mutually opposing A-pillars, a bulkhead which delimits in a longitudinal direction of the motor vehicle, and a crossbeam. The crossbeam extends transversely with respect to the longitudinal direction of the motor vehicle from a first A-pillar of the mutually opposing A-pillars to a second A-pillar of the mutually opposing A-pillars. The crossbeam is supported or mounted exclusively on the mutually opposing A-pillars. The crossbeam is in a form of a die-cast component.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a three-dimensional view of an embodiment of a crossbeam according to the present disclosure;

FIG. 2 shows a three-dimensional view of an embodiment of a schematic vehicle body with an installed crossbeam, when viewed towards the vehicle front space; and

FIG. 3 shows a three-dimensional view of an embodiment from the passenger compartment in the direction towards the vehicle front space.

### DETAILED DESCRIPTION

An embodiment of the invention provides a front region of a passenger compartment which takes into account the current trend of the passenger compartment, reduces the operating elements in the cockpit and improves the sense of space as a result of a larger and more open available space.

In an embodiment, the crossbeam is supported or mounted exclusively on the A-pillars, wherein the crossbeam is in the form of a die-cast component.

The front region according to an embodiment of the invention of a passenger compartment of a motor vehicle containing two mutually opposing A-pillars, a bulkhead which delimits in the longitudinal direction of the motor vehicle and a crossbeam. The crossbeam extends transversely with respect to the longitudinal direction of the motor vehicle continuously from one A-pillar to the opposing A-pillar. The longitudinal direction of the vehicle extends in the X direction, the Y direction extends transversely or at right-angles horizontally with respect to the longitudinal vehicle direction and the Z direction extends perpendicularly to the longitudinal vehicle direction or also the Y direction, that is to say, in a downward or upward direction. The crossbeam is exclusively supported or mounted on the A-pillars and has no additional supports on the vehicle base. This enables a continuously open footwell from the driver up to the passenger region. Consequently, a central tunnel-like member or central console is not required between the driver and the passenger. The crossbeam is in the form of a die-cast component. From the prior art there are crossbeams which are also configured without additional support on the vehicle base over the length of the crossbeam as in EP 1 388 487 A2, but these are metal pipes which have a high degree of rigidity and bridge such a large distance from one A-pillar to the next A-pillar without deflection and with adequate stability.

It is advantageous in the front region of a passenger compartment for a continuously open footwell to be formed transversely relative to the longitudinal direction of the motor vehicle from one A-pillar up to the opposing A-pillar and in the longitudinal direction of the vehicle up to the bulkhead. As a result of the lack of a support on the vehicle base the footwell is no longer separated by a central console which in most cases surrounds a support on the vehicle base, which provides improved availability of space.

Preferably, the crossbeam has at both ends end portions, wherein the crossbeam is supported or mounted exclusively on the two end portions. The end portions are secured to the A-pillars by means of the end portion connections. Preferably, this is carried out by means of a joining operation.

Preferably, a support is integrally arranged on the crossbeam and extends towards the vehicle front space in a curved manner. The support extends horizontally or in the X-Y direction, whereby the open footwell is ensured. It is advantageous for the support or the two ends of the support to integrally adjoin the two end portions of the crossbeam and to form a sweeping curve in the direction of the vehicle front space, whereby the crossbeam and the support are configured together as one component. The integral arrangement of the support on the crossbeam increases the rigidity and is inter alia also a reason for which the crossbeam does not require any support towards the vehicle base and an open footwell can be formed.

It has been found to be advantageous for a connection location to be arranged at the apex of the curved support in order to support or mount the support on the body or on the bulkhead. This connection location increases the rigidity, which is to the benefit of the crash requirements.

Preferably, a plate is arranged between the crossbeam and the support, wherein the crossbeam, the support and the plate are configured integrally or in one piece. It is advantageous for a plate to also integrally adjoin the crossbeam beside the support. This additionally increases the rigidity and also serves to ensure that the crossbeam does not require any support towards the vehicle base, and an open footwell can be formed.

It has been found to be advantageous for the crossbeam to be configured at least partially in a U-shaped manner or to have a U-shaped cross section. The U-shaped cross section also serves, on the one hand, to achieve increased rigidity and, on the other hand, to also provide a good way of guiding for the ventilation channel and/or the cables.

Preferably, the U-shape of the crossbeam is open in a downward direction, in a negative Z direction, whereby the cables and/or the ventilation channel is/are guided at the lower side.

It is advantageous for the support to be configured in a U-shaped manner. The support preferably has a U-shaped cross section. The U-shape is preferably open in a downward or in a negative Z-direction. Preferably, the U-shape is used to guide an air channel and can be connected to an HVAC unit and/or to guide cables.

It has been found to be advantageous for a leg of the U-shaped crossbeam to integrally adjoin the plate and for the plate to again integrally adjoin a leg of the U-shaped cross section of the support.

All embodiments can be freely combined with each other.

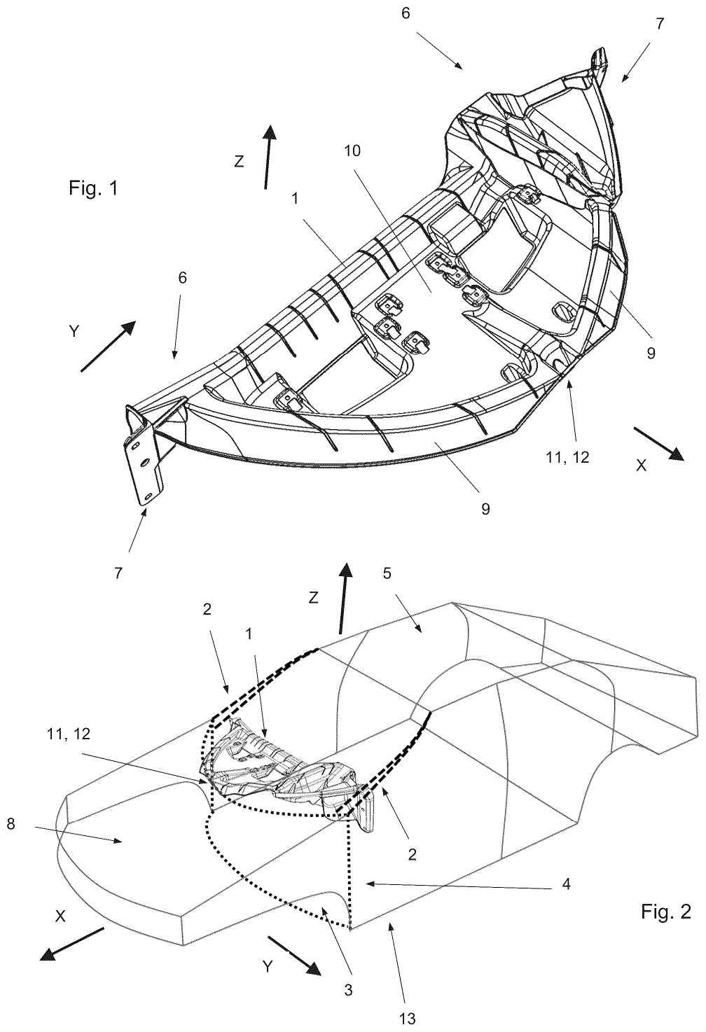

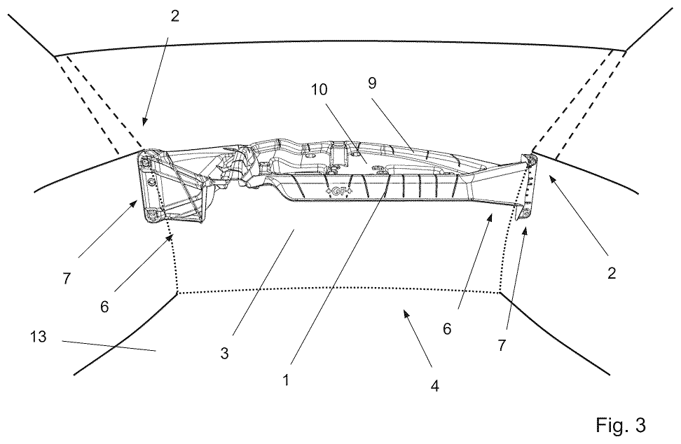

The drawing shown in FIG. 2 shows a vehicle body 5 having a front region of a passenger compartment of a motor vehicle which contains two mutually opposing A-pillars 2, a bulkhead 3 and a crossbeam 1, wherein the crossbeam 1 extends transversely Y to the longitudinal direction X of the motor vehicle from one A-pillar 2 to the opposing A-pillar 2. The crossbeam 1 is exclusively supported or mounted on the A-pillars 2, which can be clearly seen in FIG. 3. It can be clearly seen in FIGS. 1 and 2 that the crossbeam is in the form of a die-cast component. The crossbeam 1 according to an embodiment of the invention has no supports in the Z direction or in a negative Z direction on the vehicle base 13 or no supports which are supported on the vehicle base 13. FIG. 3 shows the open footwell 4 which extends continuously in the Y direction from one A-pillar 2 to the opposing A-pillar 2 and in the X direction up to the bulkhead 3. The crossbeam 1 has at both ends end portions 6 which have end portion connections 7 and by means of which it is secured to the A-pillars 2. Preferably, an integral support 9 is arranged on the crossbeam 1. The support 9 preferably extends from one end portion 6 to the other end portion 6 of the crossbeam 1 and has a curved shape which sweeps in the direction of the vehicle front space or in the X direction. The crossbeam 1 and the support 9 are configured together as one component or in one piece. It is advantageous for there to be arranged at the apex 11 of the curved support 9 a connection location 12, via which the support 9 is fixed to the body or the bulkhead 3. A preferred embodiment has been found to be when a plate 10 is integrally arranged between the crossbeam 1 and the support 9 so that the crossbeam 1, the support 9 and the plate 10 are configured together as one component. In addition, it is advantageous for the crossbeam 1 and the support 9 to have a U-shaped cross section or to be in the form of U-shaped profile and for a leg of the U-shaped profile to adjoin the plate 10 integrally in each case.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Crossbeam
2 A-pillar
3 Bulkhead
4 Footwell
5 Vehicle body
6 End portion
7 End portion connection
8 Vehicle front space
9 Support
10 Plate
11 Apex
12 Connection location
13 Vehicle base
X Longitudinal vehicle direction
Y Transverse with respect to the longitudinal vehicle direction or at right-angles horizontally with respect to the longitudinal vehicle direction
Z Perpendicularly to the longitudinal vehicle direction

1. A front region of a passenger compartment of a motor vehicle, comprising:
two mutually opposing A-pillars;
a bulkhead which delimits in a longitudinal direction of the motor vehicle; and
a crossbeam,
wherein the crossbeam extends transversely with respect to the longitudinal direction of the motor vehicle from a first A-pillar of the mutually opposing A-pillars to a second A-pillar of the mutually opposing A-pillars,
wherein the crossbeam is supported or mounted exclusively on the mutually opposing A-pillars, and
wherein the crossbeam is in a form of a die-cast component.

2. The front region according to claim 1, wherein a continuously open footwell is formed transversely relative to the longitudinal direction of the motor vehicle from the first A-pillar up to the second A-pillar and in the longitudinal direction of the vehicle up to the bulkhead.

3. The front region according to claim 1, wherein the crossbeam has at both ends end portions, and wherein the crossbeam is supported exclusively on the end portions.

4. The front region according to claim 1, wherein an integral curved support is arranged on the crossbeam and extends towards a vehicle front space.

5. The front region according to claim 4, wherein a connection location is arranged at an apex of the curved support to support or mount the curved support on a body of the vehicle or on the bulkhead.

6. The front region according to claim 4, wherein a plate is arranged between the crossbeam and the curved support, wherein the crossbeam, the curved support and the plate are configured integrally or in one piece.

7. The front region according to claim 1, wherein the crossbeam is configured at least partially in a U-shaped manner.

8. The front region of according to claim 7, wherein the U-shape of the crossbeam is open in a downward direction in a negative Z direction.

9. The front region of a passenger compartment according to claim 1, wherein the curved support is configured in a U-shaped manner.
